(19) United States
(12) Patent Application Publication
(10) Pub. No.: US 2024/0006960 A1
(43) Pub. Date: Jan. 4, 2024

(54) Electric Automobile that runs without using any other power except a battery pack and never has to be plugged in to recharge; engineering allows it to recharge itself while in movement

(71) Applicant: William Chadwick Williams, Douglas, GA (US)

(72) Inventor: William Chadwick Williams, Douglas, GA (US)

(73) Assignee: William Chadwick Williams, Douglas, GA (US)

(21) Appl. No.: 18/133,627

(22) Filed: Apr. 12, 2023

Related U.S. Application Data
(60) Provisional application No. 63/356,717, filed on Jun. 29, 2022.

(51) Int. Cl. H02K 7/18; B60K 1/04; H02K 11/00; H02J 7/14; F03G 7/10

(52) U.S. Cl. CPC H02K 7/1846; B60K 1/04; H02K 11/0094; H02J 7/14; F03G 7/115; B60L 50/60

(57) ABSTRACT

An Electric Automobile that operates on the simple principal that the wheels on it turn at High Rotations Per Minute while traveling. Thus, when the wheels are connected to an axle that spins generators; large amounts of electricity are generated. All this electricity is used to recharge the automobile's battery pack. This Process is a continuous cycle and allows the automobile to never have to use fuel or a recharge station. While in movement it constantly recharges itself.

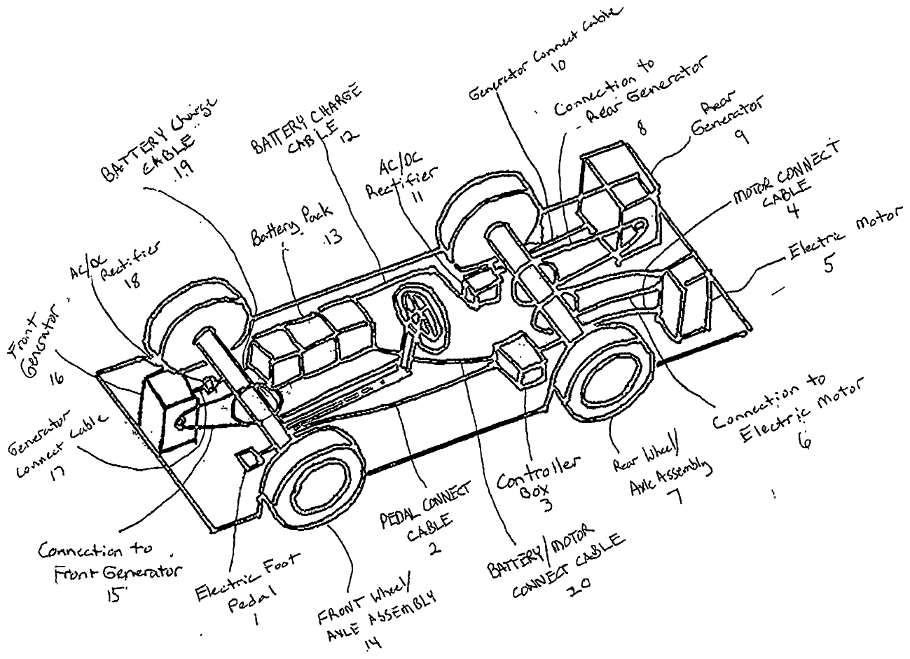

An Electric Automobile that runs without using any other power except a battery pack and never has to be plugged in to recharge; engineering allows it to recharge itself while in movement.

### CROSS-REFERENCE TO RELATED APPLICATIONS

### Reference Provisional Patent Application

APPLICATION NUMBER: 63356717

### BACKGROUND OF THE INVENTION

, Problem Solved: Fuel Cost, Electricity Cost, Time of Recharging, Saves the Environment.

Other Electric Automobiles have to use a combination of fuel and electric motors. They also have to be fueled and recharged. My auto does not have to be fueled or have any down time to recharge. It will save the owner money and help the environment.

### BRIEF SUMMARY OF THE INVENTION

, This electric auto uses high rotation of the wheels connected to axles with a shaft that spins generators to create large amounts of electricity much like wind mills to recharge while in movement; therefore, allowing the owner not to have to spend money on fuel or electricity. An owner does not have to wait several hours for the auto to recharge. The environment is saved because less carbon and other elements are released in the atmosphere by fuels used by automobiles today.

The claimed invention differs and is an improvement to what currently exists. The automobile recharges itself. There is no fuel needed or electrical recharge station needed. Using this concept of generating electricity by utilizing parts on machines that turn at high rpms and attaching generators; could be used to power all types of vehicles. For Example, the propellers of air planes could have shafts that are hooked to generators to provide power for the plane's engines and components.

### BRIEF DESCRIPTION OF THE VIEW OF THE INVENTION

1. ELECTRIC FRONT PEDAL
2. PEDAL CONNECT CABLE
3. CONTROLLER BOX
4. MOTOR CONNECT CABLE
5. ELECTRIC MOTOR
6. CONNECTION TO ELECTRIC MOTOR
7. REAR WHEEL/AXLE ASSEMBLY
8. CONNECTION TO REAR GENERATOR
9. REAR GENERATOR
10. CONNECT CABLE
11. AC/DC RECTIFIER
12. BATTERY CHARGE CABLE
13. BATTER PACK
14. FRONT WHEEL/AXLE ASSEMBLY
15. CONNECTION TO FRONT GENERATOR
16. FRONT GENERATOR
17. GENERATOR CONNECT CABLE
18. AC/DC RECTIFIER
19. BATTERY CHARGE CABLE
20. BATTERY/MOTOR CONNECT CABLE

### DETAILED DESCRIPTION OF THE INVENTION

This is an Electric Automobile that operates on the simple principal that wheels on the auto turn at High Rotations Per Minute while traveling; thus, connected to an axle that spins Generators, large amounts of electricity are generated much like how wind mills create electricity. This electricity is then harnessed and used to keep the Battery Pack on the auto in a constant state of fully charged. This Automobile is different from anything on the market today. It never has to use fuel and it never has to be recharged. Therefore, solving the problems faced by electric automobiles on the market today of owners having to pay high fuel cost and waiting for long periods for the auto to recharge or having to look for a recharging station. The environment is also saved because less carbon and other elements are released into the atmosphere.

Relationship Between the Parts:

The Electric Automobile is set in the Forward Movement Position and starts when an operator presses element 1 Electric Foot Pedal—this sends a current through element 2 Pedal Connect Cable—to element 3 Controller Box—which then pulls electric current through element 20 Battery/Motor Connect Cable and sends current through element 4 Motor Connect Cable—then element 5 Electric Motor turns—causing element 6 Connection to Electric Motor to turn element 7 Rear Wheel/Axle Assembly—this turns element 8 Connection to Rear Generator—this causes element 9 Rear Generator to begin producing Alternating Current electricity in large amounts—this electricity is sent through element 10 Generator Connect Cable—to element 11 AC/DC Rectifier where the Alternating Current is turned into Direct Current—this is sent through element 12 Battery Charge Cable—and ultimately charges element 13 Battery Pack—at the exact same time—element 14 Front Wheel/Axle Assembly turns forward-turning element 15 Connection to Front Generator—which turns element 16 Front Generator causing it to produce large amounts of Alternating Current electricity—this electricity is sent through element 17 Generator Connect Cable—to element 18 AC/DC Rectifier where the Alternating Current is turned into Direct Current—this is sent through element 19 Battery Charge Cable—and ultimately charge element 13 Battery Pack. This process is continuous as long as the automobile is in movement. The automobile recharges itself and never needs any fuel or to be recharged. It is always fully charged.

How to Make the Invention:

The Prototype of the automobile has already been completed and all the materials needed to build the automobile are on the market. A metal tubed frame with a metal bottom, a seat with a cushion and four wheels consist of the frame. I am using a 36 volt ESP Electric Throttle which is connected to an ESP 36 volt controller. I used a Unite MY1020 36 volt Electric Motor. The metal Sprockets are three ESP 6 inch and three ESP 1½ inch sprockets. Three ESP 355LF Metal Chains are used. Both Generators are STA Breese 48 volt Generators. Two ESP 48 volt Rectifiers are being used to convert the Alternating Current to Direct Current. The Battery Pack is made up of five ESP 12 volt Direct Current Batteries. All of these materials are either welded or bolted to the metal frame. I built the prototype to prove that this invention will work; however, in order to get the automobile out to the main stream public, I do realize that I will probably need to allow my patent to be used by one of the main Automobile Companies because of the producing cost.

How to Use the Invention:

The electric automobile will be used as a reliable form of transportation. Where, the owners will not have to pay the high price of fuel or have the aggravation of looking for and time spent at recharging stations. This automobile differs from anything on the market today by using its moving parts to totally recharge itself without ever needing fuel or a recharge station.

1. An Electric Automobile that uses its rotating parts to turn generators, which recharge the battery pack; which powers the electric motor in a continuous cycle without ever having to use fuel or a recharge station.

2. An Electric Automobile as in claim 1, that uses its wheels to turn generators, which recharge the battery pack; which powers the electric motor in a continuous cycle without ever having to use fuel or a recharge station.

3. An Electric Automobile as in claim 2, comprising: an electric motor, a connection to electric motor, a rear wheel/axle assembly, a connection to rear generator, a rear generator, a battery pack, a front wheel/axle assembly, a connection to front generator, a front generator.

4. An Electric Automobile as in claim 3, wherein said electric motor turns said connection to electric motor.

5. An Electric Automobile as in claim 3, wherein said connection to electric motor turns said rear wheel/axle assembly.

6. An Electric Automobile as in claim 3, wherein said rear wheel/axle assembly turns said connection to rear generator.

7. An Electric Automobile as in claim 3, wherein said connection to rear generator turns said rear generator.

8. An Electric Automobile as in claim 3, wherein said rear generator produces electricity charging said battery pack.

9. An Electric Automobile as in claim 3, wherein front wheel/axle assembly turns said connection to front generator.

10. An Electric Automobile as in claim 3, wherein said connection to front generator turns said front generator.

11. An Electric Automobile as in claim 3, wherein said front generator produces electricity charging said battery pack.

12. An Electric Automobile as in claim 3, wherein said battery pack sends electricity to said electric motor.

13. An Electric Automobile as in claim 3, wherein said electric motor turns said connection to electric motor.

14. An Electric Automobile as in claim 3, wherein said connection to electric motor turns repeating the continuous cycle of movement of the automobile, producing electricity, charging said battery pack.
